(19) United States
(12) Patent Application Publication
(10) Pub. No.: US 2004/0017771 A1
(43) Pub. Date: Jan. 29, 2004

(54) Cascade credit sharing for fibre channel links

(75) Inventors: Kreg A. Martin, Los Gatos, CA (US); Shahe H. Krakirian, Palo Alto, CA (US)

Correspondence Address: WONG, CABELLO, LUTSCH, RUTHERFORD & BRUCCULERI,, P.C., 20333 SH 249, SUITE 600, HOUSTON, TX, 77070, US

(73) Assignee: Brocade Communications Systems, Inc.

(21) Appl. No.: 10/207,361

(22) Filed: Jul. 29, 2002

(51) Int. Cl. H04J 1/16; H04J 3/14

(52) U.S. Cl. 370/229; 370/236

(57) ABSTRACT

A switch having a higher speed port, one or more slower speed ports, a larger buffer memory and numerous larger counters to achieve higher speed and longer range of communication. In one embodiment a larger switch having a larger buffer memory and larger counters connects to a smaller switch having a smaller buffer memory and smaller counters, the larger switch practically expanding the buffer memory and counters in the smaller switch. A combination of several counters can also avoid buffer overrun in any switches in the frame flow path due to the mismatch between the counter capabilities, the limitations of physical buffer spaces or the mismatch between transmission speeds. In another embodiment, the buffer spaces in several switches can be aggregated or cascaded along a frame path so that there are enough credits to maintain a high-speed transmission over a long distance.

### CROSS-REFERENCE TO RELATED APPLICATIONS

This application is related to and incorporates by reference, U.S. patent application Ser. No. 10/062,861, entitled “Methods and Devices for Converting Between Trunked and Single-Link Data Transmission in a Fibre Channel Network,” by Kreg A. Martin, filed Jan. 31, 2002.

### BACKGROUND OF THE INVENTION

1. Field of the Invention

This invention relates generally to network switching devices and more particularly to Fibre Channel switching devices having higher speed ports and lower speed ports and switching devices cascading credits from one switch to another through the fabric.

2. Description of the Related Art

The Fibre Channel family of standards (developed by the American National Standards Institute (ANSI)) defines a high speed communication interface for the transfer of large amounts of data between a variety of hardware systems such as personal computers, workstations, mainframes, supercomputers, storage devices and servers that have Fibre Channel interfaces. Use of Fibre Channel is proliferating in client/server applications which demand high bandwidth and low latency I/O such as mass storage, medical and scientific imaging, multimedia communication, transaction processing, distributed computing and distributed database processing applications. U.S. Pat. No. 6,160,813 to Banks et al. disclosed one Fibre Channel switch system, which is hereby incorporated by reference.

With the ever increasing demand for higher speed communication, even at the 1 Gb/sec or 2 Gb/sec speed, the existing Fibre Channel switches still cannot fully satisfy the high speed communication need. The current switches have limited port-to-port transmission speeds at about 2 Gb/sec or 3 Gb/sec. The current switches also have a limited transmission distance between two ports, in the neighborhood of 100 km. One factor that is limiting the transmission distance is the limited buffer spaces, or buffer-to-buffer credits which represent the buffer spaces, in a switch available to a communicating port to temporarily store data frames in transit. Another factor that is limiting the transmission distance is the capacities of the credit counters that track the usage of these buffer spaces or credits.

Whenever a port is connected to another port, a receiver in the port will advertise the number of buffer spaces the receiver has available for buffering frames, i.e. the number of credits available for the transmitter in the other side of the inter-switch link. The transmitter will set its transmitter credit counter (TCC) to the number of credits advertised by the receiver. Whenever the transmitter transmits a frame to a receiver, its transmitter credit counter is decreased by one. When the receiver receives the frame, a receiver credit counter (RCC) is increased by one. When the receiving port confirms the receipt of a frame by the next unit in the data path, the receiving port sends back a credit and reduces the receiver credit counter (RCC) by one. When the transmitting port receives the credit, the transmitter credit counter (TCC) is increased by one. When all the credits in the transmitter credit counter are used, i.e. the transmitter credit counter is zero, the transmitter cannot send more frames until some credits that are returned by the receiving port are received, i.e. the transmitter credit counter returns to a positive number.

The more buffer space a receiver has, the more credits the receiver can advertise to a transmitter. The more credits a transmitter has, the lower the chance that the transmitter has to stop and wait for more credits returning from the receiver. Thus the more buffer space, or the more credits available, the faster the transmission speed and the longer the distance can be.

The 10/062,861 application discloses a new switch with ports having a port-to-port speed up to 10 Gb/sec and a large buffer memory in the switch.

It is desirable to have a new switch that can communicate at a higher speed and over a longer distance. It is also desirable to have a new switch not only compatible with the existing switches, e.g. having bridging mechanisms to bridge the different transmission speed of different switches within a fabric, but also extend the functionality of the existing switches to preserve the value of the existing Fibre Channel network.

### SUMMARY OF THE INVENTION

A switch in one embodiment of the present invention has a higher speed port, one or more slower speed ports, a larger buffer memory and numerous larger counters to achieve higher speed and longer range of communication. In one embodiment of the present invention, when a larger switch having a larger buffer memory and larger counters connects to a smaller switch having a smaller buffer memory and smaller counters, the larger switch can practically expand the buffer memory and counters in the smaller switch. A combination of several counters can also avoid buffer over-run in any switches in the frame flow path due to the mismatch between the counter capabilities, the limitations of physical buffer spaces or the mismatch between transmission speeds. In another embodiment, the buffer spaces in several switches can be aggregated or cascaded along a frame path so that there are enough credits to maintain a high speed transmission over a long distance.

### BRIEF DESCRIPTION OF THE DRAWINGS

A better understanding of the invention can be had when the following detailed description of the preferred embodiments is considered in conjunction with the following drawings, in which:

FIG. 1 is a block diagram of a typical Fabric with connecting devices.

FIG. 2 is a block diagram of an E-chip in 10G mode, with one 10G-port and four GP-ports according to one embodiment of the present invention.

FIG. 3 is a block diagram of an E-chip in long haul mode with four GP-ports, according to a second embodiment of the present invention.

FIG. 4 is an illustration of a typical frame.

FIG. 5 is a block diagram of an embodiment of present invention with two E-chips of FIG. 2 in a 10G mode.

FIG. 6 is a block diagram of another embodiment of present invention with two E-chips in a long haul mode.

FIG. 7 is a block diagram of a third embodiment of the present invention with multiple E-chips in a long haul mode.

FIG. 8 is a block diagram of new high speed/long distance multiple-port switch using multiple E-chips and existing multiple port switches.

### DESCRIPTION OF THE PREFERRED EMBODIMENT

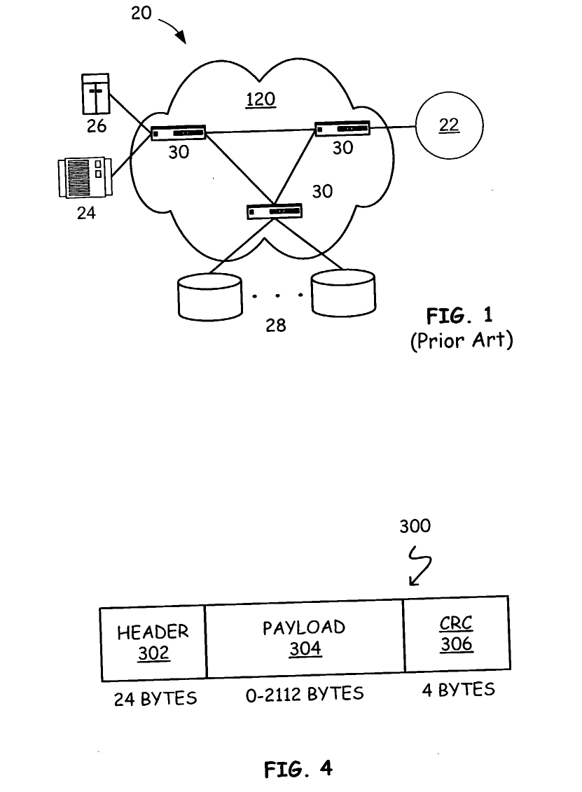

FIG. 1 depicts a typical Storage Area Network (SAN) utilizing a Fibre Channel network 20. The fabric 120 may comprise one or more switches 30. Three switches are shown. Many devices or nodes, such as a storage unit 24, a server 26, database disk drive 28 and a loop 22 (itself comprised of devices, not shown) are connected to the fabric 120. Any devices in the fabric 120 can communicate to any other devices in the fabric 120.

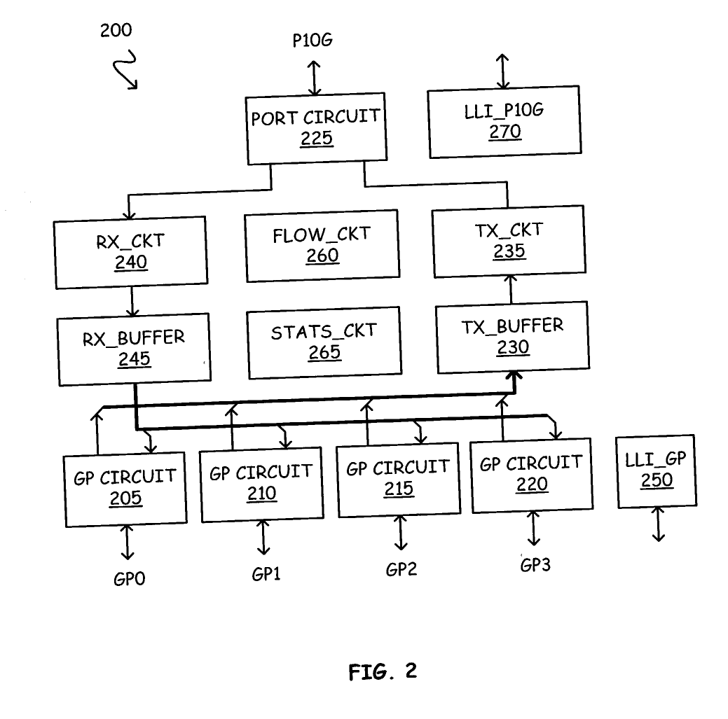

FIG. 2 shows a high level block diagram for one embodiment 200 of the present invention, called an E-chip, in 10G or high speed mode. E-chip 200 has one 10G-port 225 and four GP-ports, 205, 210, 215 and 220. A 10G-port can communicate at nominal 10 Gbps (Gigabit per second) with another port that supports such a high communication speed. A GP-port can communicate at a lower speed than a 10G-port, such as 1, 2 or 3 Gbps. The E-chip 200 has several buffer memories and many circuit groups. The buffer memories include TX buffer 230 and RX buffer 245. The RX buffer 245 is preferably large, at approximately 1 Mbyte. The circuit groups include four types of circuits: transmitter circuit 235, receiver circuit 240, flow control circuit 260 and statistics circuit 265. The E-chip 200 may also have a GP Low Level Interface (LLI_GP) 250 and a 10GP Low Level Interface (LLI_P10G) 270 for interconnection controls between the E-chip 200 and the port interface modules.

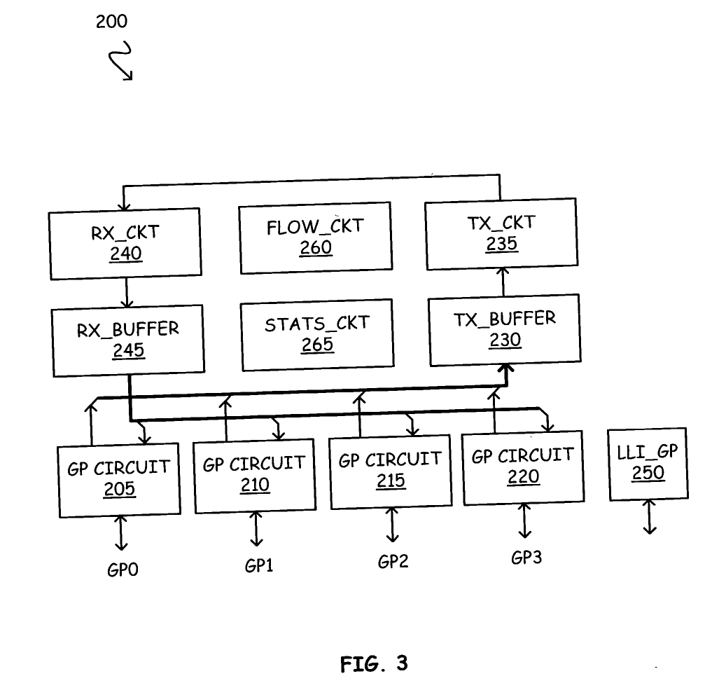

FIG. 3 shows the E-chip 200 configured in long haul mode. As shown, the transmit circuit 235 is connected to the receive circuit 240, with the port circuit 225 and the LLI_P10G circuit 270 omitted. Thus, the information may travel through an E-chip in at least two ways: between GP-ports and the 10G-port, or between the GP-ports, depending on the configuration of the E-chip 200. The 10G-port is utilized where a higher speed link is desired, while only the GP-ports are utilized when the transmission distance is more important. For more details on the 10G mode, please refer to the previously incorporated “Methods and Devices for Converting Between Trunked and Single-Link Data Transmission in a Fibre Channel Network” application.

The 10G-port can be divided into four Path Numbers, each representing a virtual GP-port, each of which has a speed closer to a physical GP-port. Each physical GP-port and the virtual GP-port can further be divided into many virtual channels. Nodes in a fabric may use the virtual channels as “dedicated connections” between them to communicate with each other. The E-chip has enough counters and buffer spaces allocated to each GP-port, virtual GP-port or Path Numbers, or virtual channels as appropriate for the particular counter or buffer space.

The four GP-ports may also be “trunked,” i.e. combined, to form a port with a higher speed. The four GP-ports may be “trunked” in any combination of 2, 3, or 4 ports in a 10G mode (i.e. a single 4-port trunk, two 2-port trunks or a single 3-port trunk with a single non-trunked port etc.) For example, in a single 4-port trunk, all four GP-ports are combined to form one logical high-speed port, very close to the 10G-port, such that the transmission speed between the GP-port side and the 10G-port side matches. In a long haul mode when only the GP-ports are being utilized, the GP-ports may be trunked in pairs.

A unit of information transferred through the fabric is called a frame. FIG. 4 describes a typical frame 300. A frame 300 includes a standard header 302, payload 304 and CRC 306. The payload 304 in a frame can vary, from zero bytes to over two thousand bytes. The size of a frame becomes important in an E-switch because an E-switch has a large buffer memory, the RX buffer 245. As discussed above, one buffer space large enough to temporarily store a frame is counted as one credit in buffer space or credit management. The size of a buffer memory in a receiver in terms of number of credits is advertised by the receiver during the initial configuration between a transmitter-receiver link.

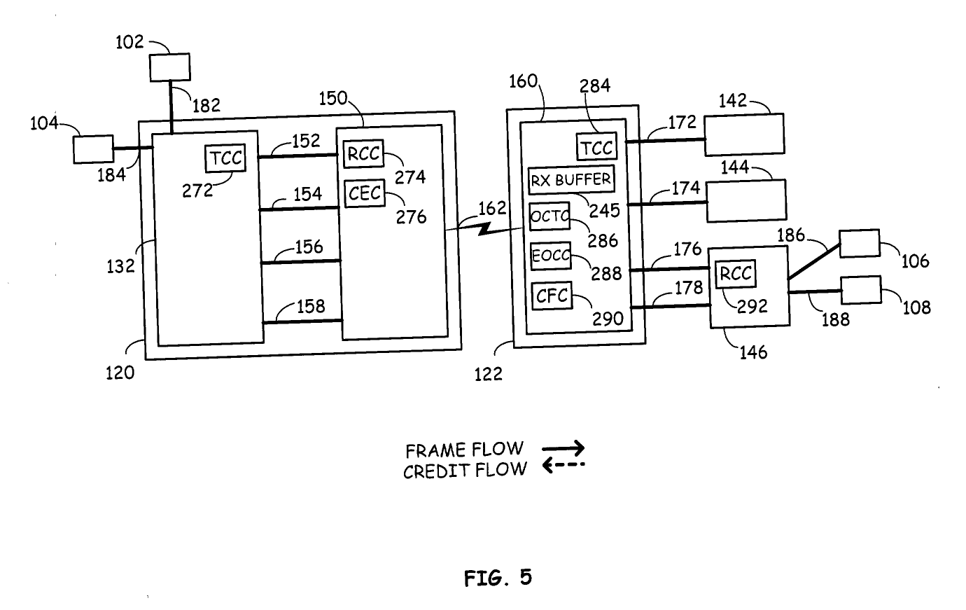

FIG. 5 depicts an embodiment of the present invention where two switches having E-chips 150 and 160 are employed in a fabric. On the left side, network nodes 102, 104 and etc. are connected to the fabric, through a B-chip 132, over links 182 and 184. The B-chip 132 is preferably a mini switch with, for example, eight GP-ports. Four GP-ports in B-chip 132 are connected to the four GP-ports in the E-chip 150 through inter-switch links (ISLs) 152, 154, 156 and 158 to form switch 120. The four GP-ports in the E-chip 150 may also connect to four GP-ports in a separate switch or GP-ports in up to four different switches if desired.

E-chip 150 is further connected to E-chip 160, which forms switch 122, through a 10G-ISL 162, which is a inter-switch link between two 10G-ports. Similar to E-chip 150, each of the four GP-ports in E-chip 160 may connect to four GP-ports in the same switch or different switches. In this example, the four GP-ports in E-chip 160 are connected through ISLs 172, 174, 176 and 178 to four GP-ports of three switches 142, 144 and 146. Each of the switches 142, 144 and 146 may connect many devices. Two nodes 106 and 108 connected to switch 146 with links 186 and 188 are shown.

To illustrate the operation of an embodiment of the present invention, the communication between node 102 and node 106 will be discussed below. Frame traffic may flow generally both ways, from left to right or from right to left. For example, from left to right: frames from node 102 in the left flow through the fabric to node 106 on the right side. From right to left, frames from node 108 in the right flow to node 104 on the left. The frame flow from left to right and the flow from right to left are independent. The flow scheme for each direction may be different to best suit needs of the particular frame flow or the flow schemes may be the same in both directions for ease of implementation. For simplicity and clarity, only the frame flow from the left to right is discussed. An upstream device is a device on the left. A downstream device is a device on the right.

Accompanying the frame flow, i.e. the data transferring, there is a corresponding credit flow, i.e. the flow of the control signals confirming the transfer of frames from a receiver to the next device in the flow (or use of the frame in an end node). The flow of credits is in the opposite direction of the frame flow, from the right to left in the following discussion.

To manage the frame and credit flow, a number of counters are used in the illustrated embodiment of the current invention. A transmitter credit counter (TCC) 272 in B-chip 132 associated with the port on ISL 152 is shown. Corresponding to TCC 272, there is a Receiver Credit Counter (RCC) 274, which is on the E-chip 150 side of ISL 152. Another counter, called the Credit Extension Counter (CEC) 276 associated with the ISL 152 in E-chip 150 is shown. There are many more equivalent counters in E-chip 150 and the B-chip 132 associated with VCs, other ISLs and with ports which are not shown.

On E-chip 160, the data receiving side of the 10G-ISL 162 for this example, there are buffers and counters, RX buffer 245, TCC 284, OCTC 286, and CFC 290, associated with the communication between nodes communicating through E-chips 150 and 160, e.g. node 102 and node 106. In one preferred embodiment, an additional counter EOCC288 may be used together with OCTC286. Their structures and use will be discussed in more detail later. E-chip 160 and switch 146 are connected through ISLs 176 and ISL 178. In switch 146, the receiving side of the ISLs 176 and 178 in this example, there is an RCC 292.

In operation, a frame from node 102 to node 106 will travel from node 102, to B-chip 132, ISL 152, E-chip 150, 10G-ISL 162, E-chip 160, ISL 174, switch 144 and finally arrive at node 106. Once node 106 receives a frame from node 102, node 106 will return an acknowledgement signal confirming the receipt of the frame. The acknowledgement, which may be represented by as a credit, travels backward through all the links and switches to node 102.

The actual flow path taken by the frames or credits from node 102 through node 106 is not of concern of this invention. An actual physical flow path through any inter-switch links may be dedicated or multiplexed, such as using virtual channels or different links in a trunk of ISLs. One physical ISL may be divided into many logical virtual channels, each of which may have its own queue, priority, credit allocation and management and flow control etc. A logical flow path is a path for frames traveling from a source, such as a node in a fabric, to its destination, such as another node. There may be other switches in between the source and the destination with different inter-switch links. Within a logical flow path, there are transmitters and receivers, just as in a real flow path. There are frame flow and credit flow and flow controllers, which manage the credits. One implementation of a logical flow path is a virtual channel in an inter-switch link, which operates just like a real physical inter-switch link. When virtual channels are used in a physical ISL, the one high speed ISL can operate as several lower speed ISLs. In the reverse, many physical ISL can be combined, or “trunked” to effectively make a high speed ISL from several slow speed ISLs.

More details on virtual channels is disclosed in U.S. application Ser. No. 09/929,627, filed Aug. 13, 2001, entitled “Quality of Service Using Virtual Channel Translation,” by David C. Banks and Alex Wang. More details on trunking is disclosed in U.S. application Ser. No. 09/872,412, filed Jun. 1, 2001, entitled “Link Trunking and Measuring Link Latency in Fibre Channel Fabric,” by David C. Banks, Kreg A. Martin, Shunjia Yu, Jieming Zhu and Kevan K. Kwong. Both of these applications are incorporated by reference.

The following discussion about flow path is only regarding the exemplary single logical flow path between node 102 and node 106. Any buffers or credits available in any switches referred to below are only the buffer space or credits in those switches available for this particular logical flow path in discussion unless otherwise noted. The total available buffer space and credits are usually more than what is available for a particular logic flow path. Some buffer space or credits and credit counters may be dedicated to a particular logical path, or others may be shared by all the logical paths within a physical path.

Still referring to FIG. 5, the transmitting device node 102 is a source of frames. The receiving device, here the node 106, is a sink of frames. As for credits, it is the opposite: node 102 is a sink and node 106 is a source. At the end of a particular data transmission session, the number of frames send by node 102, the number of frames received by node 106, the number of credits sent by node 106 and the number of credits received by node 102 are all the same. The switches in between are neither sources nor sinks for either frames or credits. The switches have no frames at the beginning and the end of any data transmission session. The number of credits in the transmitter of a switch is the same at the beginning and the end of any data transmission session, although the number many change during the transmission session. The number of credits in the transmitter of a switch is determined by the amount of credits advertised by the downstream switches or devices.

Within the E-chip, there are generally two types of frame flows. One is buffered, where a frame received by the E-chip has a frame buffer allocated to temporarily store the frame in the E-chip RX buffer 245 (i.e. credit for that frame was previously advertised based on the availability of the frame buffer in RX buffer 245). The frame is stored in the RX buffer 245 memory for a period of time that may be longer than the time necessary for receiving or transmitting a frame. The other type of frame flows is unbuffered, where a frame received by the E-chip has a frame buffer in the downstream device (e.g. 146) (i.e. credit for that frame was previously advertised based on the availability of the frame buffer in device 146). The frame received by the E-chip is retransmitted out of the E-chip as soon as the frame is received, sometimes even before the entire frame is received by the E-chip. In unbuffered frame flow the E-chip is acting as a First In First Out (FIFO) conduit. Each logical flow path can have only one type of frame flow through the E-chip, while the different logical flow paths through an E-chip generally do have different types of frame flow.

The unbuffered flow is generally used for control frames, where the data flow requires low bandwidth and the overall throughput is not of concern.

Buffered flow is generally used for bulk, usually unicast, data transfer, where a large number of frames need to be transferred. There is no interruption intrinsic to the data flow during the transmission, so the highest possible throughput with no interruption is desired. To achieve the highest possible throughput, data frames usually need to be buffered in the receiver. As discussed earlier, the more credits a receiver has, the longer the distance between the transmitter and the receiver while still maintaining a certain frame transmission rate. Therefore, in long distance transmission, buffered flow is usually used.

In the fabric shown in FIG. 5, for the frame flow through E-chip 150 from B-chip 132 towards E-chip 160, the frame flow is unbuffered. Frame flow going though E-chip 160 to switch 146 for a given logical flow path may be buffered or unbuffered, depending on the bandwidth requirements of that logical flow path.

In one embodiment of the present invention, the credits advertised by a receiver from one switch can be cascaded through the fabric to upstream switch. In the fabric shown in FIG. 5, credits advertised by a logical receiver in switch 146 can be accepted by the corresponding transmitter in E-chip 160, as usual. When the logical receiver in E-chip 160 is connected to a logical transmitter in E-chip 150, the receiver will advertise not only the credits available to it in E-chip 160 (i.e. buffer space in E-chip 160, available for the logical receiver) as usual, it may also add the amount of credits from downstream switches, here from switch 146. For example, if the receiver in switch 146 advertises 30 credits, and the receiver in E-chip 160 has 500 credits available to it, then it will advertise 530 credits to the transmitter in E-chip 150. Here the receiver in E-chip 160 is running in a buffered frame flow mode. If it is running in a unbuffered mode, when it has only a FIFO buffer, then it will only advertise 30 credits, the amount of credits it gets from downstream, to the transmitter in E-chip 150, the upstream transmitter.

To implement the above scheme to fully utilize the available large buffer space and counters, more counters, besides the conventional TCCs and RCCs, are used. One set of actions to increment and decrement those counters is listed in Table 1.

TABLE 1
The operation of the counters: increment or decrement

| | | | | | | | | |
|---|---|---|---|---|---|---|---|---|
| Switches | 132 | 150 | 150 | 160 | 160 | 160 | 162 | 142 |
| Counters | TCC | RCC | CEC | OCTC | EOCC | CFC | TCC | RCC |
| | 272 | 274 | 276 | 286 | 288 | 290 | 284 | 292 |
| Frame sent | −1 | | | +1 | −1 | | −1 | |
| downstream | | | | | | | | |
| Frame received from | | +1 | | −1 | | | | +1 |
| upstream | | | | | | | | |
| Credit sent upstream | | −1 | −1 | | +1 | −1 | | −1 |
| Credit received from | +1 | | +1 | | | +1 | +1 | |
| downstream | | | | | | | | |

−1 means decrement the counter; +1 means increment the counter.

CEC (Credit Extension Counter)

One advantage of one embodiment of the present invention is to expand the credit counter capacities of existing switches. One example is the credit extension counter CEC 276 in E-chip 150 which effectively extends capacity of the transmission credit counter TCC 272.

TCCs in many existing switches, such as B-chips in Silkworm 3800, a switch commercially available from Brocade Communications Systems, Inc., are 6-bit counters, which can only count up to 63. The buffer memory space available to a receiver in such a switch is about 64 kbyte, or less than 30 credits for maximum length frames. So a TCC in a B-chip is more than adequate when a B-chip connects to another B-chip, which can advertise at a maximum less than 30 credits. When a B-chip connects to an E-chip, which may advertise hundreds or thousands of credits (or more, as will be discussed later), then the TCC in the B-chip is inadequate. In one embodiment of the present invention, a new counter CEC, used in combination with the existing TCC, to relieve such problem. A CEC in an E-chip is a 16-bit counter, with 15 counting bits, which can count up to 32768. The CEC is used in combination with the TCC to provide the capability to count a larger number of transmitted outstanding frames.

As soon as a frame sent from B-chip 132 reaches E-chip 150, E-chip 150 can immediately send a credit back to B-chip 132, without waiting for a credit returning from a downstream device, a switch or a node. Whenever E-chip 150 sends back a credit to B-chip 132, CEC 276 decrements. Whenever E-chip 150 receives a credit from downstream switch 160, CEC 276 increments. The initial value of CEC 276 is equal to the number of credits advertised by the downstream device minus the maximum capacity of the TCC in B-chip 132. For example, if the downstream device advertises 530 credits and the maximum capacity of the TCC is 63, the initial CEC value is 467. When CEC 276 goes down to zero, E-chip 150 can no longer send credit back to B-chip 132. When CEC 276 goes down to zero, there are at least as many buffer spaces left in E-chip 150 or downstream switches as the number of credits in B-chip 132. This ensures that there is always buffer space available to buffer frames sent by the B-chip 132. The RCC 274 tracks the number of frames received by E-chip 150 whose credits have not returned back. Wherever E-chip 150 receives a frame, RCC 274 increments. Whenever E-chip 150 returns a credit, RCC 274 decrements. Whenever RCC 274 is zero, E-chip 150 will not return any credit, because no frame has been sent by B-chip 132 and received by E-chip 150. Thus, since TCC 272 gets credits from CEC 276 soon after E-chip 150 receives frames from B-chip 132, TCC 272 is not likely to run out of credit until CEC 274 runs out of credit, so CEC 274 effectively enlarges the size of TCC 272 to the combined size of CEC 274 and TCC 272.

OCTC, CFC (Outstanding Credit Threshold Counter, Credit Forwarding Counter)

The 10G-port is much faster than a GP-port, even faster than the 4 trunked GP-ports in many conditions. In a buffered frame flow mode, credits from the downstream switch, i.e. switch 146, may not be advertised to upstream switch, here E-chip 150. So all frames sent by E-chip 150 and received by E-chip 160 are buffered in E-chip 160. E-chip 160 will forward these frames to downstream switch 146 at its convenience, which will be dictated by the credits advertised by switch 146. When TCC 284 runs out of credits, which is set by credit advertised by switch 146, it cannot send more frames. Therefore, E-chip 160 or switch 146 cannot be overrun by E-chip 150. Additional speed throttling or bridging is not necessary.

In an unbuffered frame flow mode, however, it is possible that E-chip 150 can send more frames than E-chip 160 can accept. Therefore it is necessary to have a mechanism to bridge the speed difference. In another embodiment of the present invention, a Credit forwarding counter CFC 290 and an Outstanding Credit Threshold Counter OCTC 286 are used, in part for this purpose. In a preferred embodiment, an Excess Outstanding Credit Counter EOCC 288 may also be used.

Credit forwarding counter CFC 290 in E-chip 160 is used to coordinate the upstream credit flow through E-chip 160 to E-chip 150. Whenever E-chip 160 receives a credit from switch 146, CFC 290 increments. Whenever E-chip 160 sends a credit back to E-chip 150, CFC 290 decrements. CFC 290 is initialized to zero. When CFC 290 reaches zero again, E-chip 160 cannot send credit to E-chip 150. The E-chip 160 is using CFC 290 or the returned credits to throttle the speed of the upstream switch down to the speed of the slower downstream switch.

OCTC 286 represents the number of frames that can be held in the buffer memory before credits to upstream devices are withheld in order to prevent buffer memory overrun. EOCC 288, when used, represents the number of outstanding credits supported by devices downstream of E-chip 160 which are advertised to devices upstream of E-chip 160.

Whenever a frame is sent downstream from E-chip 160, OCTC 286 increments and EOCC 288 decrements. Whenever a frame is received from upstream by E-chip 160, OCTC 286 decrements. Whenever a credit is sent upstream by E-chip 160, EOCC 288 increments.

When the OCTC value is less than 1, then E-chip 160 cannot send credits back upstream to E-chip 150, even if E-chip 160 has received credits back from downstream devices, such as switch 146.

Once E-chip 160 withholds credits returned from downstream devices, E-chip 150 or B-chip 132 will not have enough credit to keep sending frames down to E-chip 160. E-chip 150 will have to wait for more returned credits from E-chip 160, therefore, E-chip 160 will not be overrun.

The parameters and functions used for calculating the initialization values of OCTC and EOCC when used may be as follows:

ICREDIT is the credit advertised for the flow path supported by frame buffers in the downstream devices, such as switch 146.

F_THR is Frame Count Threshold: A threshold of the number of frames that are temporarily buffered in the flow path. If the threshold is exceeded, the forwarding of credits (RDY primitives) from the GP-port to the 10G-port may be held off in order to prevent an overrun.

GP_FRAME_RATE is the minimum rate at which maximum-sized frames can be transferred on a GP. This takes into account the inter-frame gap.

NUM_GP is the Number of GP-ports (typically 4).

XG_FRAME_RATE is the the maximum rate at which maximum-sized frames can arrive from 10GFC. This assumes a minimum inter-frame gap of one word.

UNBUF_NUM_FRAMES is the number of maximum-sized frames for which the un buffered segment may have space reserved on a switch. UNBUF_NUM_FRAMES is calculated by the following equation in one preferred embodiment:

UNBUF_{—}NUM_FRAMES=min(ICREDIT, (SPEED_{—}MATCH_FRAMES+F_{—}THR+2*NUM_{—}GP))

Where min(a, b) is a function to return the value of the lesser of a and b.

SPEED_MATCH_FRAMES=roundup((ICREDIT−F_{—}THR)*SPEED_INDEX)

Where SPEED_INDEX is defined below:

$$SPEED\_INDEX = 1 - \frac{GP\_FRAME \_RATE * NUM\_GP}{XG\_FRAME \_RATE}$$

Roundup( ) is a function to round up a value to next higher integer

Case 1, where the combined frame rate of all GP-ports is higher than the 10G-port frame rate. The counters for this case may be initialized as follows:

F_THR=0

OCTC=7 FFh (maximum positive value)

EOCC=0

Since the combined frame rate of all GPs is higher than the 10G-port, the E-chip 160 cannot be overrun, and EOCC and OCTC are not necessary, so they are initialized to their extreme values.

Case 2, where the combined frame rate of all GP-ports is lower than the 10G-port frame rate. The recommended value is calculated as follows:

F_THR may be 8 or higher otherwise and applies,

F_{—}THR=max(8, roundup(ICREDIT*SPEED_INDEX))

The counters for this case may be initialized as follows:

OCTC=F_THR

EOCC=ICREDIT

The following numeric examples show the initialization of the OCTC and EOCC counters:

Assuming GP-ports run at a nominal 3 Gbps:

ICREDIT=32 (a downstream switch advertises 32 credits);

GP_FRAME_RATE=146.2 kframe/s

XG_FRAME_RATE=592.47 kframe/s

NUM_GP=4

Then SPEED_INDEX=0.0129

F_THR=8

SPEED_MATCH_FRAMES=1UNBUF_NUM_FRAMES=17

OCTC=8 and EOCC=32

Another numerical example, where the GP-ports run at a nominal 2 Gbps:

Assuming ICREDIT=64 (a downstream switch advertises 64 credits);

GP_FRAME_RATE=97.47 kframe/s

XG_FRAME_RATE=592.47 kframe/s

NUM_GP=4

Then SPEED_INDEX=0.342

F_THR=22

SPEED_MATCH_FRAMES=15

UNBUF_NUM FRAMES=45

OCTC=22 and EOCC=64

Long Haul Mode

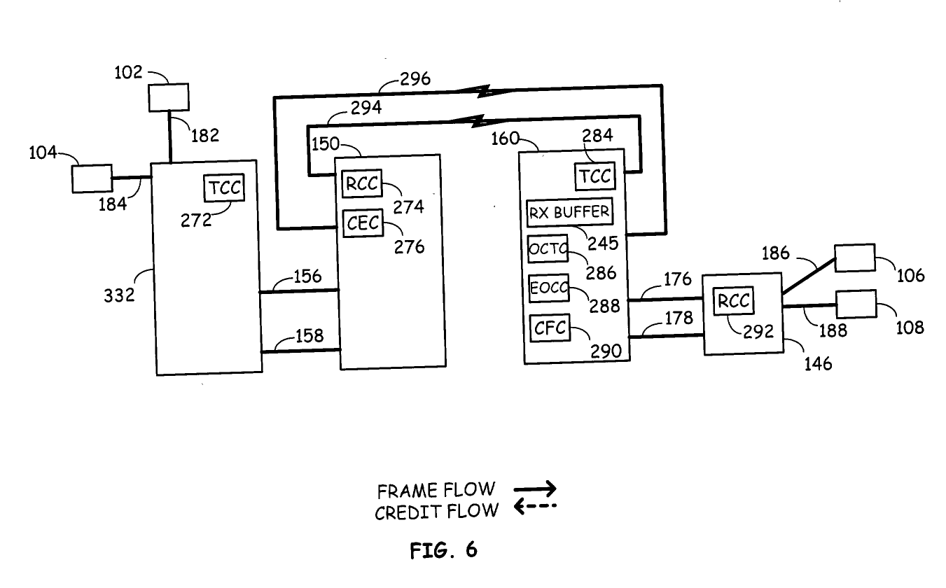

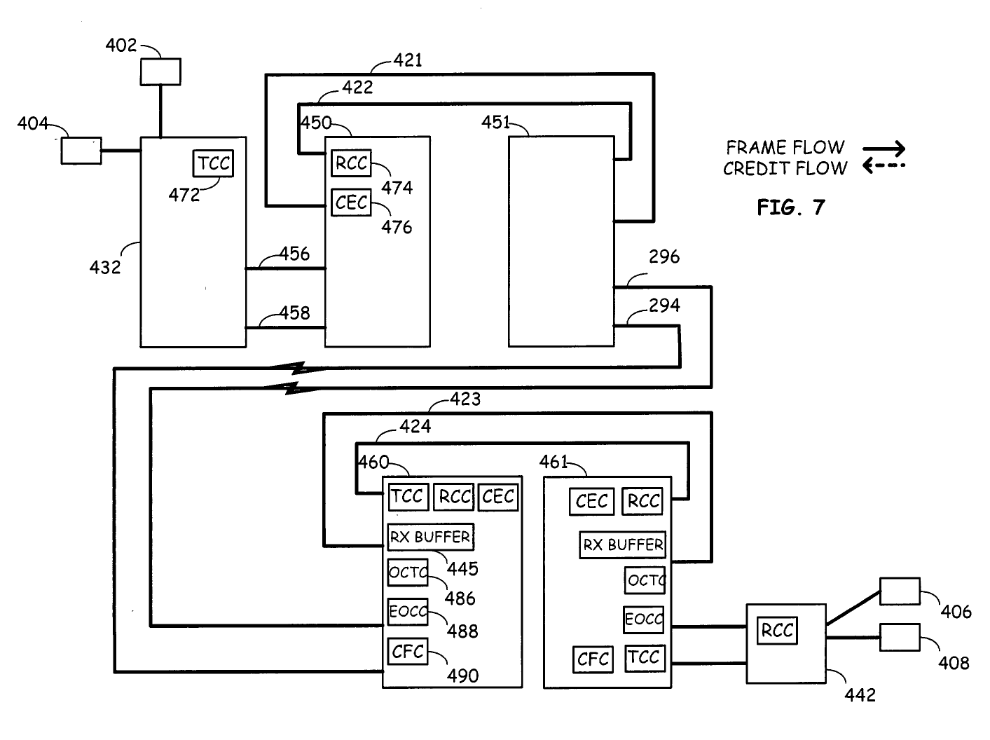

A second embodiment of the present invention where the maximum transmission speed is exchanged for maximum transferring distance, i.e. the long haul mode of operation, is shown in FIGS. 6 and 7.

In FIG. 6, two E-chips are used in long haul, so there are no 10G-ports. Two GP-ports in E-chip 150 and two GP-ports in E-chip 160 are connected through ISLs 296 and 294. These two ISLs 296 and 294 are trunked as one link. The distance between the two switches having E-chip 150 and 160 can be very long, such as several hundred kilometers. The number of links to E-chips is reduced from four GP-ports to only two GP-ports. The available buffer spaces in the E-chips are now shared by two GP-ports.

As discussed earlier, at a certain frame transmission rate, the longer the distance, the more credit a receiver needs to advertise to the transmitter. The size of the receiver buffer needed at certain frame transmission rate for certain distance, in terms of number of frames or credit can be determined by the following formula:

$$TOTAL\_NUM \_FRAMES = roundup ( \frac{2 * dist * Gbaud * R1 * 1000}{3 * MAX\_FRAME \_SIZE} ) + 8$$

Where roundup(x) is a function to get the next integer greater than x;

dist is the distance between the two communicating ports in kilometers;

Gbaud is the rate of receive link, 1.0625 for 1 Gbps, 2.125 for 2 Gbps, 3.1875 for 3 Gbps etc.;

RI is the Refractive index of the fiber, assuming 1.5 for the worst case;

MAX_FRAME_SIZE is the size of maximum length frame, which is 2148 bytes;

8 is a typical number representing the latency within a switch.

A third numerical example:

Assuming the transmission speed between the ports at 2 Gbps for 500 km, and an RI equal to 1.5, the required buffer space in the receiver is:

TOTAL_{—}NUM_FRAMES=roundup(2*500*2.125*1.5*1000/3/2148)+8=503

For a typical E-chip, the buffer space can store about 500 maximum sized frames. This means that a typical E-chip has enough buffer space to support a data transmission at 2 Gbps for up to about 500 km. For longer distance transmission, a switch with more buffer space is necessary.

Credit Cascading

As shown in the last numeric example, one E-chip only has enough buffer space to sustain 500 km long transmission at a nominal 2 Gbps rate. In another embodiment of the current invention, instead of requiring one single switch or chip having a very large buffer, several chips can pool their buffer space to make one virtual chip having a very large buffer. Furthermore, this virtual chip can be flexible and expandable to whatever size necessary.

In FIG. 7, two E-chips (450, 451, 460, 461) in each switch on each side of a long distance link (294, 296) are used to make more buffer space available for the long distance communication need. E-chips 450 and 451 act as one E-chip 150 in FIG. 6 and E-chips 460 and 461 act as one E-chip 160 in FIG. 6. Similar as in FIG. 6, all of the 10G-ports, 464, 466, 467, 468 are left unused. On the receiving side of the long haul inter-switch links 294 and 296, credit cascading is from right to left, in the direction of credit flow. In a certain logical flow path, a B-chip 442 advertises the amount of credits (assuming 30) available to the flow path to E-chip 462. This advertised credit will initialize the TCC in E-chip 461. Then the first E-chip 461 will advertise the amount of credit available to the flow path, which would be the amount of buffer space (500 credits for example) in the first E-chip 461 plus credits from B-chip 442 (30 credits), for a total of 530 credits. Similarly, the second E-chip 460 will advertise 500+530=1030 credits to E-chip 150. Thus it is clear that the transmitter in E-chip 451 can send 1030 frames without receiving any credits returned back from an end device such as 406 or 408. Therefore, the maximum distance of the long haul inter-switch link can be about 1000 km at the same nominal 2 Gbps speed as in FIG. 6. If longer distance transmission is desired, one can simply increase the number of E-chips used in one switch as in FIG. 7. The maximum distance at a predetermined speed is proportional to the number of E-chips used in the receiver side of the long haul link. In the above example, at nominal 2 Gbps, each E-chip has enough buffer space for 500 km. So if the distance desired is×km, then the number E-chips needed is roundup (×/500). For example, if the distance is 2100 km, the number of E-chips needed is roundup (2100/500)=5.

In the cascaded credit configuration, the frame flow through the E-chip is equivalent to a combination of a buffered flow and an unbuffered flow. Thus, the frame buffers required in E-chip and the counter initialization values are calculated as follows, using E-chip 460 in FIG. 7 as an example:

The frame buffers required in E-chip 460 are the sum of two parts, part (1) frame buffers advertised by it (i.e. 500 in this example) and part (2) frame buffers needed for an equivalent unbuffered flow for frame buffers advertised by the downstream devices (i.e. unbuffered flow for 530 downstream credits).

The frame buffers needed in E-chip 460 for part (1) is called BUF_NUM_FRAMES and is 500 in this example. The frame buffers needed in E-chip 460 for part (2) is called UNBUF_NUM_FRAMES, which is calculated using equations similar to the equations for the unbuffered segment in 10G mode. One different equation is as follows:

$$SPEED\_INDEX = 1 - \frac{SND\_FRAME \_RATE}{RCV\_FRAME \_RATE}$$

where RCV_FRAME_RATE is the maximum rate at which frames may be received from the upstream device, and SND_FRAME_RATE is the minimum guaranteed rate at which frames are sent to the downstream device when credits are available. This formula for SPEED_INDEX is almost the same as used in the 10G mode. The only difference is in the nomenclature so that the formula is more relevant to this credit cascading case.

For this example, assume that RCV_FRAME_RATE=194.94 kframe/s and SND_FRAM_RATE is 5% lower, i.e. 185.19 kframe/s, then:

SPEED_INDEX=0.05

ICREDIT in this example is 530 (sum of credits advertised by E-chip 461 and B-chip 442), therefore:

F_THR=27

SPEED_MATCH_FRAMES=26

UNBUF_NUM_FRAMES=57.

Thus, the total number of frame buffers needed in E-chip 460 is:

BUF_NUM_FRAMES+UNBUF_NUM_FRAMES=500+57=557.

The counters for this case are initialized as follows:

OCTC=BUF_NUM_FRAMES+F_THR

EOCC=ICREDIT

In this example, the counters in E-chip 460 are initialized as follows:

OCTC=500+27=527

EOCC=530

The buffer space reserved for unbuffered segment in a cascade mode is slightly larger than in a regular 10G mode, in a preferred embodiment, as illustrated in the last example. The buffer space requirement for unbuffered segment in an E-chip is proportional to the number of credits advertised by downstream devices. The number of credits advertised by downstream devices could be very large. The total buffer space on an E-chip is fixed. Therefore, the actual advertised number of credits from an E-chip may be slightly less in a cascade long haul mode than in a 10G mode.

The switches on either side of the long haul link shown in FIG. 7 are symmetric, i.e. each has the same number of E-chips, but that depends on the data transmission needs in the direction. For example, if data transmission in one direction is much more than the other direction, i.e. not symmetric, then the switches need not be symmetric. For example, if there are only data transmission from nodes on the left to the nodes on the right, then only one E-chip is needed on the left while there are four E-chips needed on the right side.

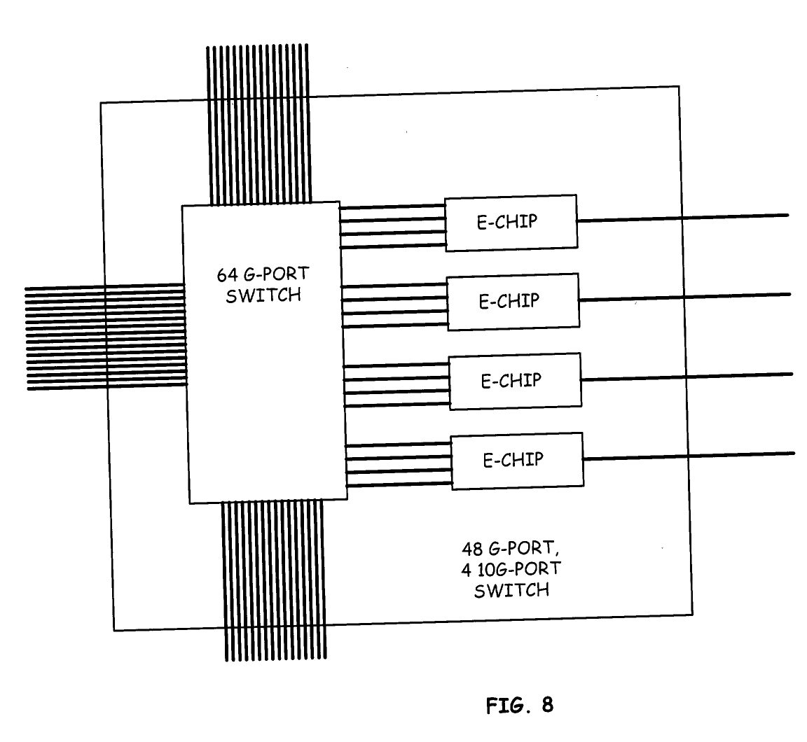

FIG. 8 depicts one new switch implementing an embodiment of the present invention. Four E-chips are connected to 16 GP-ports of a commercially available 64-port switch to make a new switch. This new switch has 48 GP-ports and 4 10G-ports. This new switch may be used in 10G mode to connect up to 4 10G-ports or nodes supporting 10G speed at one size, or 48 switches or nodes supporting 1, 2 or 3G speed. It can also be used in long haul mode for transmission distance up to 2000 km at 2 Gbps speed.

In the above description, various counters have been described as incrementing or decrementing based on given conditions. Further, various actions or non-actions have been described as occurring based on counter values Additionally, exemplary equations for providing initial values of the various counters have been described. It is understood that any or all of the counters could be constructed to operate in the opposite manner from that described, such operation being equivalent to the described operation. For example, the CEC could increment when credit sent upstream and decrement when credit is received from upstream. The initial value and actions or non-actions based on CEC values would then also be changed to reflect this inversion of the described counting operation. It is thus understood that various changes to the counters, related actions and initial values can be made, such as inverting the counting operation, which changes would be fully equivalent to the described operations.

Titles and subtitles used in the text are intended only as focal points and an organization tool. These titles are not intended to specifically describe the applicable discussion or imply any limitation of that discussion.

1. A device comprising:
a first Fibre Channel port;
a second Fibre Channel port;
a first counter communicating with both the first Fibre Channel port and the second Fibre Channel port; and
a second counter communicating with both the first Fibre Channel port and the second Fibre Channel port,
wherein the first counter is operable to increment when the first Fibre Channel port receives a frame and decrement when the first Fibre Channel port sends a credit, and
wherein the second counter is operable to increment when the second Fibre Channel port receives a credit and decrement when the first Fibre Channel port sends a credit.

2. The device as in claim 1,
wherein the first Fibre Channel port is a slower Fibre Channel port compared to the second Fibre Channel port.

3. The device as in claim 1,
wherein when the first Fibre Channel port is connected to a third Fibre Channel port and the second Fibre Channel port is connected to a fourth Fibre Channel port, the first counter is operable to be set to a first number and the second counter is operable to be set to a second number.

4. The device as in claim 3, wherein the first number is zero.

5. The device as in claim 3, wherein the second number is positive.

6. The device as in claim 1,
wherein when the fourth port advertises a number of credits and the third port has a transmitter credit counter with a maximum value, the second number equals to the number of credits advertised by the fourth port minus the maximum value of the transmitter credit counter in the third port.

7. The device in claim 1, further comprising:
third and fourth counters communicating with both the first and second Fibre Channel ports,
wherein the third counter is operable to increment when the first Fibre Channel port sends a frame and decrement when the second Fibre Channel port receives a frame, and
wherein the fourth counter is operable to increment when the first Fibre Channel port receives a credit and decrement when the second Fibre Channel port sends a credit.

8. The Fibre Channel switch in claim 7,
wherein the second port is prohibited from sending credits when the third counter is less than zero.

9. The Fibre Channel switch in claim 7, wherein the second port is prohibited from sending credits when the fourth counter is less than one.

10. The device in claim 7, further comprising:
a fifth counter communicating with the first and the second Fibre Channel ports,
wherein the fifth counter is operable to increment when the first Fibre Channel port receives a credit and decrement the first Fibre Channel port sends a frame.

11. The device in claim 10, wherein when the first Fibre Channel port is connected a third Fibre Channel port, the fifth counter is operable to be set to a number equal to the number of credits advertised by the third Fibre Channel port.

12. A device comprising:
a first Fibre Channel port;
a second Fibre Channel port; and
first and second counters communicating with both the first Fibre Channel port and the second Fibre Channel port,
wherein the first counter is operable to increment when the second Fibre Channel port sends a frame and decrement when the first Fibre Channel port receives a frame; and
wherein the second counter is operable to increment when the second Fibre Channel port receives a credit and decrement when the first Fibre Channel port sends a credit.

13. The device as in claim 12, further comprising:
a third counter communicating with the first Fibre Channel port and the second Fibre Channel port,
wherein the third counter is operable to increment when the second Fibre Channel port receives a credit and decrement the when second Fibre Channel port sends a frame.

14. The device as in claim 13,
wherein when the second Fibre Channel port connects to a third Fibre Channel port, the third counter is operable to be set to a number equal to the number of credits advertised by the third Fibre Channel port.

15. A device as in claim 12,
wherein the first Fibre Channel port is a faster Fibre Channel port compared to the second Fibre Channel port.

16. A Fibre Channel switch comprising:
a first port;
a second port;
a buffer memory having a plurality of buffers, communicating with both the first port and the second port; and
a control module having a plurality of credits representing the buffers, communicating with both the first port and the second port, and controlling one or more logical flow paths within the switch; and
a first counter and a second counter within a logical flow path communicating with both the first port and the second port;
wherein the first counter is operable to increment when the first port receives a frame for the logical flow path and decrement when the first port sends a credit for the logical flow path, and
wherein the second counter is operable to increment when the second port receives a credit for the logical flow path and decrement when the first port sends a credit for the logical flow path.

17. The Fibre Channel switch as in claim 16, wherein the first port is a slower port compared to the second port.

18. The Fibre Channel switch as in claim 16,
wherein when the first port is connected to a third port and the second port is connected to a fourth port, the first counter is operable to be set to a first number and the second counter is operable to be set to a second number.

19. The Fibre Channel switch as in claim 18, wherein the first number is zero.

20. The Fibre Channel switch as in claim 18, wherein the second number is positive.

21. The Fibre Channel switch as in 18,
wherein the fourth port advertises a number of credits for the logical flow path and the third port has a transmitter credit counter for the logical flow path with a maximum number,
the second number equals to the number of credits advertised by the fourth port minus the maximum value of the transmitter credit counter in the third port.

22. The Fibre Channel switch in claim 16, further comprising:
third and fourth counters communicating with both first and second ports;
wherein the third counter is operable to increment when the first port sends a frame and decrement when the second port receives a frame; and
wherein the fourth counter is operable to increment when the first port receives a credit and decrement when the second port sends out a credit.

23. The Fibre Channel switch in claim 22,
wherein the second port is prohibited from sending credits when the third counter is less than zero.

24. The Fibre Channel switch in claim 22, wherein the second port is prohibited from sending credits when the fourth counter is less than one.

25. The Fibre Channel switch in claim 22, further comprising:
a fifth counter communicating with the first port and the second port;
wherein the fifth counter is operable to increment when the first port receives a credit and decrement the first port sends a frame, and
wherein the first port is prohibited from sending frames when the fifth counter is less than one.

26. The Fibre Channel switch in claim 25, wherein when the first port is connected a third port, the fifth counter is set to a number of credits advertised by the third port.

27. The Fibre Channel switch in claim 22, wherein when the second port connects to a fourth port, the fourth counter is set to zero.

28. The Fibre Channel switch as in claim 18, wherein the first port is prohibited from sending credit when the second counter is less than one.

29. A Fibre Channel switch comprising:
a fast port and a plurality of slow ports;
a buffer memory communicating with both the fast port and the slow-ports;
a control module communicating with both the fast port and the slow ports and controlling one or more logical flow paths; and
a logical flow path having first and second counters,
wherein the first counter is operable to increment when the second port sends a frame over the logical flow path and decrement when the first port receives a frame over the logical flow path, and
wherein the second counter is operable to increment when the second port receives a credit for the logical flow path and decrement when the first port sends a credit for the logical flow path.

30. The Fibre Channel switch in claim 29,
wherein the fast port is prohibited from sending credits for the logical flow path when the first counter is less than zero, and
wherein the fast port is prohibited from sending credits for the logical flow path when the second counter is less than one.

31. The Fibre Channel switch as in claim 29, further comprising:
a third counter in the logical flow path,
wherein the third counter is operable to increment when a slow port receives a credit over the logical flow path and decrement when a slow port sends a frame over the logical flow path, and
wherein any slow ports are prohibited from sending frames over the logical flow path when the third counter is less than one.

32. The Fibre Channel switch as in claim 29,
wherein when a slow port for the logical flow path connects to a fourth port, the third counter is operable to be set to the number of credits advertised by the fourth port for the logical flow path.

33. The Fibre Channel switch as in claim 29,
wherein when the fast port connects to a third port,
the fast port is operable to advertise a first number of credits for the logical flow path,
the first counter is operable to be set to a second number, and
the second counter is operable to be set to zero.

34. The Fibre Channel switch as in claim 33,
wherein the first number of credits is a number of credits in the control module representing the number of frames allocated in the buffer memory for the logical flow path plus the number of credits advertised by the fourth port for the logical flow path.

35. The Fibre Channel switch as in claim 33,
wherein the first number of credits is a number of credits in the control module representing the number of frames allocated to the buffer memory for the logical flow path.

36. The Fibre Channel switch as in claim 35,
wherein the fast port has a total frame receiving rate;
wherein the slow ports have a total frame retransmission rate, which is less than the total frame receiving rate;
wherein the second number is determined by the following formula:
second number=max(8, roundup(SPEED_INDEX*(first number))),
where
SPEED_INDEX=1−(total frame retransmission rate)/(total frame receiving rate),
max (a, b) is a function returning the larger number of a and b, and
roundup(x) is a function returning the next integer greater than x.

37. The Fibre Channel switch as in claim 33, wherein the first number of credits is the number of credits advertised by the fourth port for the logical flow path.

38. A Fibre Channel fabric for an information network comprising:
a first switch including:
a first memory having a plurality of buffers;
a first control module communicating with the first memory; and
first and second ports communicating with the first memory; and
a second switch including:
a second memory having a plurality of buffers;
a second control module communicating with the second memory
a third port and a fourth port communicating with the second memory, the third port connected to the second port and having a plurality of logical flow paths; and
first and second counters for a logical flow path,
wherein the first counter increments when the third port receives a frame over the logical flow path and decrements when the third port sends a credit for the logical flow path, and
wherein the second counter increments when the fourth port receives a credit over the logical flow path and decrements when the third port sends a credit for the logical flow path.

39. The Fibre Channel fabric in claim 38,
wherein the third port is prohibited from sending credit for the logical flow path when the second counter is less than one.

40. The Fibre Channel fabric in claim 39, wherein the fourth port is faster than any one of the first port, the second port and the third port.

41. The Fibre Channel fabric in claim 40,
wherein the first counter is initialized to a first number, and the second counter is initialized to a second number.

42. The Fibre Channel fabric in claim 41, wherein the first number is zero.

43. The Fibre Channel fabric in claim 41, wherein the second number is positive.

44. The Fibre Channel fabric in claim 41,
wherein the second number equals the number of credits advertised to the fourth port for the logical flow path minus the maximum value of the transmitter credit counter in the second port for the logical flow path.

45. The Fibre Channel fabric in claim 44, further comprising:
a third switch having a third memory;
a third control module communicating with the third memory;
a fifth port communicating with the third memory, connecting to the fourth port in the second switch and having one or more logical flow paths;
a sixth port communicating with the third memory; and
third and fourth counters for the logical flow path; and
a fourth switch having a fourth memory;
a fourth control module communicating with the fourth memory;
a seventh port communicating with the fourth memory and connected to the sixth port in the third switch; and
an eighth port communicating with the fourth memory,
wherein the third counter is operable to increment when the sixth port sends a frame over the logical flow path and decrement when the fifth port receives a frame over the logical flow path,
wherein the fourth counter is operable to increment when the sixth port receives a credit for the logical flow path and decrement when the fifth port sends out a credit for the logical flow path,
wherein the fifth port is prohibited from sending credits for the logical flow path when the third counter is less than zero; and
wherein the fifth port is prohibited from sending credits for the logical flow path when the fourth counter is less than one.

46. The Fibre Channel fabric in claim 45,
wherein the third switch further has a fifth counter for the logical flow path,
wherein the fifth counter is operable to increment when the sixth port receives a credit from the seventh port for the logical flow path and to decrement when the sixth port sends a frame to the seventh port over the logical flow path, and
wherein the fifth counter is initialized to a third number.

47. The Fibre Channel fabric in claim 46, wherein the third number is the number of credits advertised by the seventh port for the logical flow path.

48. The Fibre Channel fabric in claim 47,
wherein the fifth port advertises a fourth number of credits for the logical flow path, the third counter is set to a fifth number.

49. The Fibre Channel fabric in claim 48,
wherein the fourth number of credits is the number of credits in the third switch allocated for the logical flow path.

50. The Fibre Channel fabric in claim 49,
wherein the fifth number is the maximum value of the third counter.

51. The Fibre Channel fabric in claim 48,
wherein the fourth number of credits is the third number plus the number of credits allocated in the third switch for the logical flow path.

52. The Fibre Channel fabric in claim 48,
wherein the fourth number of credits is same as the third number.

53. The Fibre Channel fabric in claim 52,
wherein the fifth number is determined by the following formula:
fifth number=max(8, roundup (SPEED_INDEX*(fourth number))),
where
SPEED_INDEX=1−(total frame transmission rate out the third switch through ports other than the fifth port)/(total frame transmission rate into the third switch through the fifth port),
max (a, b, . . . ) is a function returning the largest number in the argument, and
roundup(x) is a function returning the next integer greater than x.

54. The Fibre Channel fabric in claim 48,
wherein the third switch further has an RCC counter and a CEC counter;
wherein the second switch further has an OTCC counter, an EOCC counter, a CFC counter, and a TCC counter,
wherein the RCC counter is operable to increment when the sixth port receives a frame and decrement when the sixth port sends out a credit,
wherein the CEC counter is operable to increment when the fifth port receives a credit and decrement when the sixth port sends out a credit,
wherein the sixth port is prohibited from sending credit when the CEC counter is less than one,
wherein the OTCC counter is operable to increment when the third port sends a frame and decrement when the fourth port receives a frame,
wherein the EOCC counter is operable to increment when the fourth port sends a credit and decrement when the third port sends out a frame,
wherein the CFC counter is operable to increment when the third port receives a credit and decrement when the fourth port sends out a credit,
wherein the fourth port is prohibited from sending credits when the OTCC counter is less than one and the EOCC counter is not less than zero, and
wherein the fourth port is prohibited from sending credits when the CFC counter is less than one.

55. A Fibre Channel fabric for an information network comprising:
a first switch including:
a first memory having a plurality of buffers,
a first control module communicating with the first memory and having a plurality of credits representing buffers in the first memory; and
first and second ports communicating with the first memory; and
a second switch including:
a second memory having a plurality of buffers,
a second control module communicating with the second memory and having a plurality of credits representing buffers in the second memory;
first and second counters communicating with the second memory;
a third port communicating with the second memory and connected to the second port;
a forth port communicating with the second memory and of a faster speed than the third port, and
a fifth port communicating with the second memory and of the same speed as the third port;
a third switch including:
a third memory having a plurality of buffers;
a third control module communicating with the third memory and having a plurality of credits representing buffers in the third memory;
a sixth port communicating with the third memory, and connected to the fifth port, having one or more logical flow paths,
a seventh port communicating with the third memory and of a faster speed than the sixth port; and
an eighth port communicating with the third memory and of the same speed as the sixth port; and
a fourth switch including:
a fourth memory having a plurality of buffers;
a fourth control module communicating with the fourth memory and having a plurality of credits representing buffers in the fourth memory;
a ninth port communicating with the fourth memory and connected to the eighth port; and
a tenth port communicating with the fourth memory,
wherein the first counter increments when the third port receives a frame over a logical flow path and decrements when the third port sends a credit for the logical flow path, and
wherein the second counter increments when the fifth port receives a credit for the logical flow path and decrements when the third port sends a credit for the logical flow path.

56. The Fibre Channel fabric as in claim 55,
wherein the first counter is set to a first number which is zero;
wherein the second counter is set a second number which equals to the value advertised by the sixth port for the logical flow path minus the maximum value of the transmitter credit counter in the second port for the logical flow path.

57. The Fibre Channel fabric as in claim 55,
wherein the connection between the fifth port and the sixth port is longer than any other connections between the second and third switches or the eighth and ninth switches.

58. The Fibre Channel fabric as in claim 55,
wherein the third switch further comprises third and fourth counters for the logical flow path,
wherein the third counter is operable to increment when the eighth port sends a frame over the logical flow path and decrement when the sixth port receives a frame for the logical flow path,
wherein the fourth counter is operable to increment when the eighth port receives a credit for the logical flow path and decrement when the sixth port sends out a credit for the logical flow path,
wherein the sixth port is prohibited from sending credits for the logical flow path when the third counter is less than zero; and
wherein the sixth port is prohibited from sending credits for the logical flow path when the fourth counter is less than one.

59. The Fibre Channel fabric as in claim 58,
wherein the receiver in sixth port advertises a number of credits for a logical flow path equal to the number of credits in the third switch for the logical flow path plus the number of credits advertised by the receiver in the ninth port for the logical flow path,
wherein the third counter is set to a third number that is less than the number of credits allocated in the third switch for the logical flow path, and
wherein the fourth counter is set to zero.

60. The Fibre Channel fabric as in claim 59, wherein the third number equals the number of credits advertised by the receiver in the ninth port for the logical flow path minus eight.

61. The Fibre Channel fabric as in claim 58,
wherein the receiver in the sixth port advertises a number of credits for a logical flow path equal to the number of credits advertised by the receiver in the ninth port for the logical flow path,
wherein the third counter is set to the maximum value of the third counter, and
wherein the fourth counter is set to zero.

62. An information network system comprising:
a first node;
a first switch including:
a first memory having a plurality of buffers;
a first control module communicating with the first memory and having a number of credits representing the plurality of buffers in the first switch;
a first port communicating with the first memory and connected to the first node;
a transmitter credit counter communicating with the first memory, and
a second port communicating with the first memory;
a second switch including:
a second memory having a plurality of buffers;
a second control module communicating with the second memory and having a number of credits representing the plurality of buffers in the second switch;
first and second counters communicating with the second memory; and
a third port and a forth port communicating with the second memory, the third port connecting to the second port;
a third switch including:
a third memory having a plurality of buffers;
a third control module communicating with the third memory and having a number of credits representing the plurality of buffers in the third switch;
a fifth port communicating with the third memory and connecting to the fourth port;
a sixth port communicating with the third memory; and
a fourth switch including:
a fourth memory having a plurality of buffers;
a fourth control module communicating with the fourth memory and having a number of credits representing the plurality of buffers in the fourth switch;
a seventh port communicating with the fourth memory and connected to the sixth port; and
an eighth port communicating with the fourth memory; and
a second node connected to the eighth port,
wherein the first counter increments when the third port receives a frame and decrements when the third port sends a credit,
wherein the second counter increments when the fourth port receives a credit and decrements when the third port sends a credit, and
wherein the first and the second counters are initialized to a first number and a second number, respectively.

63. The system in claim 62, wherein the first node is a server.

64. The system in claim 62, wherein the first node is a storage unit.

65. The system in claim 62, wherein the second node is a server.

66. The system in claim 62, wherein the second node is a storage unit.

67. The system in claim 62, wherein the fourth port and the fifth port are higher speed Fibre Channel ports than any of the first, second, third, the sixth, seventh and eighth ports.

68. The system in claim 62, wherein the first number is zero.

69. The system in claim 62,
wherein the first counter and the second counter are used for a logical flow path, and
wherein the second number equals the number of credits advertised to the fourth port for the logical flow path minus the maximum value of the transmitter credit counter.

70. The system in claim 62,
wherein the third switch further comprises:
third and fourth counters communicating with the third memory,
wherein the third counter is operable to increment when the sixth port sends a frame and decrement when the fifth port receives a frame,
wherein the fourth counter is operable to increment when the sixth port receives a credit and decrement when the fifth port sends out a credit,
wherein the fifth port is prohibited from sending credits when the third counter is less than zero,
wherein the third and fourth counter are initialized to third and fourth numbers, respectively; and
wherein the fifth port is prohibited from sending credits when the fourth counter is less than one.

71. An information network system comprising:
a first node;
a first switch including:
a first memory having a plurality of buffers;
a first control module communicating with the first memory and having a plurality of credits representing buffers in the first memory;
a transmit credit counter communicating with the first memory; and
first and second ports communicating with the first memory, the first port connecting to the first node; and
a second switch including:
a second memory having a plurality of buffers;
a second control module communicating with the second memory and having a plurality of credits representing buffers in the second memory;
first and second counters communicating with the second memory;
a third port communicating with the second memory and connected to the second port;
a fourth port communicating with the second memory and of a faster speed than the third port; and
a fifth port communicating with the second memory and of the same speed as the third port;
a third switch including:
a third memory having a plurality of buffers;
a third control module communicating with the third memory and having a plurality of credits representing buffers in the third memory;
a sixth port communicating with the third memory, connected to the fifth port and having a plurality of logical flow paths;
a seventh port communicating with the third memory and of a faster speed than the sixth port; and
an eighth port communicating with the third memory, and of same speed port as of sixth port; and
a fourth switch including:
a fourth memory having a plurality of buffers;
a fourth control module communicating with the fourth memory and having a plurality of credits representing buffers in the fourth memory;
a ninth port communicating with the fourth memory and connected to the eighth port; and
a tenth port communicating with the fourth memory; and
a second node connected to the tenth port;
wherein the first counter increments when the third port receives a frame over a logical flow path and decrements when the third port sends a credit for the logical flow path, and
wherein the second counter increments when the fifth port receives a credit for the logical flow path and decrements when the third port sends a credit for the logical flow path.

72. The information network as in claim 71,
wherein the first counter is set to a first number which is zero, and
wherein the second counter is set a second number which equals the number advertised by the sixth port for the logical flow path minus the maximum value of the transmitter credit counter.

73. The information network as in claim 71, wherein the connection between the fifth port and the sixth port is longer than any other connection between the first and second switches or the third and fourth switches.

74. The information network as in claim 71,
wherein the third switch further comprises third and fourth counters for the logical flow path,
wherein the third counter is operable to increment when the eighth port sends a frame over the logical flow path and decrement when the sixth port receives a frame over the logical flow path,
wherein the fourth counter is operable to increment when the eighth port receives a credit for the logical flow path and decrement when the sixth port sends out a credit for the logical flow path,
wherein the sixth port is prohibited from sending credits for the logical flow path when the third counter is less than zero, and
wherein the sixth port is prohibited from sending credits for the logical flow path when the fourth counter is less than one.

75. The information network as in claim 74,
wherein the receiver in the sixth port advertises a number of credits for a logical flow path equal to the number of credits allocated in the third switch for the logical flow path plus the number of credits advertised by the receiver in the ninth port for the logical flow path,
wherein the third counter is set to a third number that is less than the number of credits in the third switch for the logical flow path, and
wherein the fourth counter is set to zero.

76. The information network as in claim 75, wherein the third number equals the number of credits advertised by the receiver in the ninth port for the logical flow path minus eight.

77. The information network as in claim 74,
wherein the sixth port advertises a number of credits for a logical flow path equal to the number of credits advertised by the receiver in the ninth port for the logical flow path,
wherein the third counter is set to the maximum value of the third counter, and wherein the fourth counter is set to zero.

78. A method to extend buffer memory and counter capacities in a first switch in a Fibre Channel network using a second switch, wherein the first switch has a TCC counter, a first port and a second port; wherein the second switch has a first counter, a second counter, a second buffer memory, a control module, a third port and a fourth port; and wherein the first switch and the second switch are connected through a inter-switch link between the second port and third port, the method comprising the steps of:
dividing the inter-switch link into one or more logical flow paths;
initializing the TCC counter at a first number for a logical flow path;
initializing the first counter at a second number for the logical flow path;
assigning a third number of credits for the logic flow path from the second buffer memory;
initializing the second counter to a fourth number equal to the third number minus the first number;
incrementing the first counter when the third port receives a frame over the logical flow path;
decrementing the first counter when the third port sends a credit for the logical flow path;
incrementing the second counter when the fourth port receives a credit for the logical flow path;
decrementing the second counter when the third port sends a credit for the logical flow path;
incrementing the TCC counter when the second port receives a credit for the logical flow path;
decrementing the TCC counter when the second port sends a frame over the logical flow path;
prohibiting the third port from sending credits for the logical flow path when the second counter is less than one; and
sending a credit from the third port to the second port for the logical flow path whenever the third port receives a frame from the second port over the logical flow path and the third port is not prohibited from sending credits.

79. The method in claim 78, wherein the first number is the maximum value of the first counter.

80. The method in claim 78, wherein the second number is zero.

81. The method in claim 78, wherein the fourth port is a higher speed than the third port.

82. A method to avoid buffer overrun in a logic flow path in a Fibre Channel network including
a first switch having:
a first slow speed port;
a second fast speed port; and
a memory control module communicating with the first and the second ports;
a second switch having:
a third fast speed port connected to the second port in the first switch;
a plurality of slow speed ports;
a memory module communicating with the third port and the slow speed ports and having a plurality of buffers;
a memory control module communicating with the memory module and having a number of credits representing the buffers in the memory module in the second switch; and
first and second counters communicating with the memory control module; and
a third switch having:
a fifth slow speed port connected to a slow port in the second switch;
a sixth slow speed port;
a memory control module and communicating with the fifth port and the sixth port, the method comprising the steps of:
advertising a number of credits for a logical flow path to the first switch;
initializing the first counter to a first number;
initializing the second counter to a second number;
incrementing the first counter when the fourth port sends a frame;
decrementing the first counter when the third port receives a frame;
incrementing the second counter when the fourth port receives a credit;
decrementing the second counter when the third port sends a credit;
prohibiting the third port from sending credits when the first counter is less than zero; and
prohibiting the third port from sending credits, when the second counter is less than one.

83. The method in claim 82, wherein the number of credits advertised to the first switch equals a number of credits in the second switch plus the number of credits advertised by the fifth port.

84. The method in claim 82, wherein the number of credits advertised to the first switch equals a number of credits advertised by the fifth port.

85. The method in claim 84,
wherein the first number is determined by the following formula:
(first number)=max(8, roundup(SPEED_INDEX*(the number advertised to the first switch))),
where
SPEED_INDEX=1−(total frame transmission rate out the second switch through ports other than the third port)/(total frame transmission rate into the second switch through the third port),
max (a, b, . . . ) is a function returning the largest number in the argument, and
roundup(x) is a function returning the next integer greater than x.

86. A method to increase the buffer space available to a receiver for a logical flow path on a receiving side of a long distance Fibre Channel communication network, the logical flow path having a predetermined frame transmission rate and predetermined distance and requiring a predetermined number of credits to sustain the predetermined transmission rate at the predetermined distance,
the method comprising:
selecting a type of Fibre Channel switch wherein the switch has credit counters with maximum counting capacities greater than the predetermined number and the switch has ports supporting the predetermined frame transmission speed;
determining a number n of Fibre Channel switches needed, wherein the number n equals the roundup ((predetermined number of credits)/(number of credits in one switch)), where roundup(x) is a function returning the next integer greater than x;
connecting the number of Fibre Channel in series, wherein the nth switch connects to the transmitting side through the long distance link;
the receiving port in the first switch advertising a first number of credits which is the number of credits in the first switch to the transmitting port in a second switch connected to the receiving port in the first switch, and a transmitter credit counter in the second switch is set to the first number;
the receiving port in the second switch advertising a second number of credits which is the sum of the number of credits in the second switch plus the first number advertised by the first switch;
repeating the last two steps, until the nth switch, wherein the nth switch advertising the nth number of credits which is the sum of the number of credits in the nth switch plus the (n−1)th number of credits advertised by the (n−1)th switch.

87. A Fibre Channel switch comprising:
a first port;
a second port;
a buffer memory having a plurality of buffers, communicating with both the first port and the second port; and
a control module having a plurality of credits representing the buffers, communicating with both the first port and the second port, and controlling one or more logical flow paths within the switch; and
wherein the control module is operable to advertise a first number of credit for a flow path through the first port to a third port when the third port is connected to the first port;
wherein the control module is operable to acknowledge a second number of credit advertised from a fourth port for the flow path through the second port when the fourth port is connected to the second port;
wherein the first number equals to the sum of the second number and the number of credits on the switch allocated by the control module to the flow path.
